(19) United States
(12) Patent Application Publication
(10) Pub. No.: US 2013/0149459 A1
(43) Pub. Date: Jun. 13, 2013

(54) METHOD FOR THE SURFACE TREATMENT OF A FLUID PRODUCT DISPENSING DEVICE

(71) Applicants: Pascal Bruna, Rouen (FR); Denis Busardo, Gonneville Sur Mer (FR)

(72) Inventors: Pascal Bruna, Rouen (FR); Denis Busardo, Gonneville Sur Mer (FR)

(73) Assignee: APTAR FRANCE SAS, Le Neubourg (FR)

(21) Appl. No.: 13/807,888

(22) PCT Filed: Jul. 1, 2011
(86) PCT No.: PCT/FR11/51544

§ 371 Date: Feb. 25, 2013

(30) Foreign Application Priority Data
Jul. 2, 2010 (FR) 1055343
Jul. 16, 2010 (FR) 10/02989

(51) Int. Cl. B01J 19/08

(52) U.S. Cl. CPC B01J 19/085
USPC 427/523

(57) ABSTRACT

A method of surface treating a fluid dispenser device, the method including a step of modifying, by ion implantation using multi-charged and multi-energy ion beams, at least one surface to be treated of at least a portion of the device in contact with the fluid. The modified surface has properties limiting the formation of a biofilm and thus the appearance and/or proliferation of bacteria on the modified surface, the multi-charged ions being selected from helium, boron, carbon, nitrogen, oxygen, neon, argon, krypton, and xenon, ionic implantation being carried out to a depth of 0 μm to 3 μm.

The present invention relates to a method of surface treating fluid dispenser devices.

Fluid dispenser devices are well known. They generally comprise a reservoir, a dispenser member such as a pump or a valve, and a dispenser head provided with a dispenser orifice. Particularly in the pharmaceutical field, the risk of contaminating the fluid to be dispensed may be critical, especially when such fluids are free of preservatives. Thus, nasal or oral dispenser devices may become contaminated bacterially. Such contamination may occur in the reservoir in which the fluid is stored, in particular via bacteria penetrating through the dispenser orifice or outside the reservoir on contact with a patient, in particular around the dispenser orifice. The appearance and/or multiplication of bacteria on a given surface primarily depend on the presence of a biofilm that forms on said surface. In order to limit such risks of bacterial contamination, proposals have been made to filter venting air or to use pumps that do not return air. It is also possible to provide a valve directly upstream of the dispenser orifice that prevents the proliferation of bacterial contamination towards the reservoir between consecutive uses of the device. Such solutions are insufficient for external surfaces, however, for example the walls that come into contact with the interior of the nostrils when dispensing nasally. They are also insufficient for internal surfaces, in particular during the dispensing stage when any valve is in the open position. In order to further limit the risks of bacterial contamination inside and outside the devices, suggestions have been made for certain internal and/or external surfaces that are to come into contact with the fluid to be dispensed to be coated with bactericidal and/or bacteriostatic substances, for example layers containing silver ions. The following documents describe various prior art solutions: EP0473892, EP0580460, EP0831972, U.S. Pat. No. 6,227,413, EP1169241, DE2830977, U.S. Pat. No. 5,154,325, EP0644785, U.S. Pat. No. 5,433,343, EP0889757. However, those solutions are unsatisfactory. The efficacy and durability of such coatings are thus open to debate; in general, they are not capable of satisfying regulatory requirements concerning bacteriological tests for preservative-free drug dispensers.

Thus, the aim of the present invention is to propose a surface treatment method that does not suffer from the above-mentioned disadvantages.

In particular, the present invention aims to provide a surface treatment method that is effective, long-lasting, non-polluting, that does not interact with the fluid, and that is simple to carry out.

In a particular aspect, the invention proposes a method of grafting monomers in a deep layer in an organic material by using an ion beam.

In particular, the invention aims to reduce the proliferation of bacteria, in particular on the tips of nasal sprays between taking consecutive doses of a drug.

The term “organic” means a material constituted by carbon atoms bonded together or to other atoms via covalent bonds. By way of example, this category includes materials belonging to the family of polymers, elastomers, or resins. Such organic materials have the specific feature of generally being electrical insulators and being capable of producing free radicals under the effect of ionizing radiation; this includes ultraviolet (UV), X-ray, or gamma (γ) ray radiation, electron beams, and ion beams.

As an example, under ionizing radiation, a covalent bond of the C═C type produces two free radicals, denoted (.), each located on one carbon atom (.C—C.) and each being capable of combining with other molecules (for example O₂) in radical reactions characterized by three steps, the first being initiation, the second being propagation, and the third being inhibition.

The term “monomer” means a simple molecule used for the synthesis of polymers. In order to be capable of being grafted to an organic material, these monomers must have unsaturated bonds (for example a double bond) that are capable of reacting with the free radicals produced in the organic material by the ionizing radiation.

Exposing a polymer material to ionizing radiation of the electron bombardment or gamma radiation type creates free radicals (ionization reaction) that can either combine together by reactions known as cross-linking reactions, thereby creating new covalent bonds between atoms of the organic material, or that can be used to graft monomers from outside with the atoms of the organic material. The free radicals react with monomers having a vinyl or acrylic type unsaturated bond. The ionizing radiation by electronic bombardment or gamma radiation and associated irradiation units can be used to graft supports in very different formats: films, textile surfaces, compound-filled granules, medical devices, for example. A monomer carrying a graftable vinyl, allyl, or acrylic type unsaturated bond may be bonded onto a carbon chain under the effect of ionizing radiation. Depending on the other chemical functions (or ligands) carried by the monomer, the support material may be permanently endowed with particular characteristics: antiseptic properties, ion exchange properties, adhesion promoting properties, etc.

Electronic bombardment or gamma radiation grafting methods may, however, suffer from disadvantages linked to the means for producing the ionizing particles and to their range, which has the effect of greatly limiting their use.

Units producing gamma rays are extremely difficult to manage from both a technical and a safety standpoint. They consist of a radioactive cobalt-60 source in the form of rods confined in a shielded compartment made of concrete with 2 m [meter] thick walls. The compartment also houses a pool for storing the source stock, intended to provide biological protection when the source is in the “rest” position. In the “working” position, an overhead conveyor carrying containers (also known as trays) moves the items to be treated around the source suspended in the cell and also transfers the items between the interior and the exterior of the compartment. The labyrinthine configuration ensures that the radiation is confined while allowing the items to pass through continuously. The power of the source may reach several million Curies.

All units producing electron beams are also difficult to use. Thick shielding systems must be provided to stop the intense X rays that are produced by deceleration of electrons in the material. Further, the electron beams may cause breakdowns by an accumulation of electrostatic charges in the core of an insulating organic material.

Another disadvantage, this time physical, is linked to the excessive penetrating power of gamma radiation (several meters) and of electrons (several mm [millimeter]). Penetrating powers of such magnitudes are not suitable for a treatment where it is the surface that is to be treated, but without modifying the bulk properties of the organic material. In fact, it is not desirable for an elastomer to lose its bulk elastic properties and to increase in stiffness to a point where it could no longer, for example, match the shape of a shaped surface (a windshield, for example).

A further grafting method exists, this time acting at the extreme surface using a cold plasma. Cold plasmas are ionized media obtained by exciting a gas (in general under low vacuum) under the effect of an electrical discharge: radiofrequency plasmas (kHz to MHz [kilohertz to megahertz]) and microwave plasmas (2.45 GHz [gigahertz]) are the most widely used. A mixture is obtained thereby that is constituted by neutral molecules (in the majority), ions (negative and positive), electrons, radical species (chemically very active), and excited species. Such plasmas are termed “cold” since they are media that are not in thermodynamic equilibrium, where the energy is essentially captured by the electrons, but where the “macroscopic” temperature of the gas remains close to ambient temperature. The electrons emitted by the electrode collide with the molecules of the gas and activate them. Ionization or dissociation then occurs with the creation of radicals. These excited species diffuse into the chamber of the reactor and in particular reach the surface of the substrate. There, a number of types of surface reaction may occur: implantation at very low energies (a few nm [nanometers]), energy transfer, and the creation or destruction of bonds. Depending on the type of reaction occurring at the surface, the surface may be activated, a layer may grow, or etching may occur. Chemical grafting with cold plasmas consists in operating with gases such as oxygen, nitrogen, air, ammonia, or tetrafluorocarbon with active species that react chemically with the macromolecular chains of the polymer to lead to the formation of covalent bonds (C—O, CN, C—F, etc.) that are characteristic of the treatment gas. That type of treatment affects the first nanometers only of the surface exposed to the plasma. The surface of a polymer that has been activated in that manner may then be brought into contact with specific biocompatible molecules (heparin, phospholipids, etc.) to bind them via chemical bonds. In general, chemical grafting is carried out by placing the material to be treated outside the zone where the discharge is created (post-discharge). Because the graft thicknesses are very small, the treatment has a limited lifespan. It is also sensitive to the service conditions (wear, friction, abrasion) that may cause it to disappear very early on.

This gives rise to a need for a method of deep layer grafting of an organic material, preferably using methods that are readily industrializable, in order to be able to offer such organic materials in significant quantities and at reasonable cost.

Thus, the invention also aims to offer a method of deep layer grafting an organic material that is inexpensive and that can be used to treat surfaces complying with the needs of many applications.

Thus, the invention proposes a method of deep layer grafting an organic material by means of an ion beam, which method comprises two steps:

a) ionic bombardment, wherein:
the ions of the ion beam are selected from the ions of elements from the list constituted by helium (He), boron (B), carbon (C), nitrogen (N), oxygen (O), neon (Ne), argon (Ar), krypton (Kr), and xenon (Xe);
the ion acceleration voltage is greater than or equal to 10 kV [kilovolts] or less than or equal to 1000 kV;
the temperature of the organic material is less than or equal to its melting temperature;
the ion dose per unit area is selected so as to be in the range 10¹² ions/cm² to 10¹⁸ ions/cm² in order to create, by ionic bombardment, a layer constituting a reservoir of free radicals that can be used for grafting monomers during a second step. This reservoir of free radicals is characterized by a surface layer with a thickness of the order of a few micrometers. This reservoir of free radicals may optionally be separated from the ambient medium by an extreme surface layer that is completely cross-linked by the ionic bombardment and that is essentially constituted by amorphous carbon. This layer of amorphous carbon at the extreme surface, which is by nature less reactive, has a stabilizing effect on the reservoir of free radicals relative to the ambient medium and can be used to increase the surface hardness of the organic material;

b) a step of grafting monomers, consisting in diffusing the monomers from the surface towards the reservoir of free radicals at a diffusion temperature that is carefully selected to graft them to molecules present in said reservoir. The diffusion temperature must be selected so as to:
activate the free radicals present in the treated thicknesses (stabilizing layer+free radical reservoir);
accelerate the process of diffusion of monomers from the surface through the stabilizing layer towards the free radical reservoir;
accelerate the radical mechanisms resulting in grafting of the monomers to molecules present in the reservoir; and
guarantee that the properties of the organic material are not spoilt during the return to ambient temperature.

In one implementation, the glass transition temperature Tg appears to be the most suitable. Another implementation allows the option of exploring temperatures intermediate between the glass transition temperature Tg and the melting temperature, subject to precautions being taken concerning cooling conditions to ensure that the properties of the original organic material are regained. Finally, a third implementation allows the option of exploring temperatures included between ambient temperature and the glass transition temperature if the density and reactivity of the free radicals and the rate of diffusion of the monomers are sufficiently high to greatly shorten the grafting periods. The choice of diffusion temperature depends greatly on the nature of the organic material and the graftable monomer.

The choice of ions and the bombardment conditions of these ions in accordance with the invention can advantageously be used to identify a reservoir of free radicals with an optimized density for deep layer grafting of monomers over a thickness of the order of one micrometer and at high density, which monomers may have properties that are hydrophobic, hydrophilic, antibacterial, or even conductive. It is thus possible to create thick, highly effective barriers of a hydrophobic, hydrophilic, antibacterial, or even conductive nature. Examples that may be mentioned are:
hydrophilic monomers: acrylic acid;
hydrophobic monomers: 2-(perfluoro-3-methylbutyl)ethylmethacrylate, 3-(perfluoro-3-methylbutyl)-2-hydroxypropyl methacrylate;
antibacterial monomers: dimethyloctyl ammonium ethylmethacrylate, bromide or chloride, ethylene glycol methacrylate phosphate-silver ion complex.

The inventors have been able to show that the ranges selected in the invention for the acceleration voltage and for the ion dose per unit area can be used to select optimized experimental conditions where deep layer grafting is possible by means of ionic bombardment, while treating thicknesses of the order of one micrometer.

Furthermore, they have been able to show that the method of the invention may be used “cold”, in particular at ambient temperature, and that the temperature of the organic material remains less than or equal to the melting temperature during implementation of the method. Thus, advantageously, it is possible advantageously to avoid physico-chemical modification of the organic material or self-combination of the free radicals.

The method of the invention has the advantage of modifying the surface characteristics of the organic material over a thickness of the order of one micrometer without altering its bulk properties.

The choice of the ion dose per unit area in the range of doses of the invention may result from a previous calibration step where a sample constituted by the envisaged organic material is bombarded with one of the ions selected from He, B, C, N, O, Ne, Ar, Kr, and Xe. Bombardment of this organic material may be carried out in different zones of the material using a plurality of ion doses within the range of the invention, and the change of the surface resistivity of the treated zones over time is measured under ambient conditions in order to identify a resistive jump that is characteristic of very rapid oxidation of the reservoir of free radicals underlying the surface, with this happening after a period that is linked to the diffusion of oxygen in the organic material.

The inventors have been able to show that the magnitude of the resistive jump provides an estimate of the density of free radicals present in the reservoir, and that the choice of dose for a given organic material must be based on that which induces the greatest resistive jump.

The measurement of surface resistivity in the treated zones, expressed as Ω/□ [ohm per square], is carried out in accordance with IEC standard 60093.

Without wishing to be bound by any particular scientific theory, it may be considered that this phenomenon of resistive jump can be explained by the diffusion of oxygen from the air towards the reservoir of free radicals, followed by its very rapid combination, by radical mechanisms, with the molecules present in that zone. This oxidation process has the effect of suddenly reducing the density of free radicals, or in other words the surface conductivity. When the change with time of the surface resistivity of the organic material is analyzed, this is shown up by a resistive jump exhibited in the form of a step. At a higher dose, these free radicals disappear, leaving amorphous carbon in place with electrical properties that are very stable over time. The change of surface resistivity of the organic material then remains constant over time. The method of the invention is capable of identifying a resistive jump indicating the presence of this deep layer reservoir of free radicals. The magnitude of the step provides an estimation of the density of free radicals present in this reservoir and should be selected so as to be as great as possible.

In addition to reinforcing the hydrophobic, hydrophilic and antibacterial properties intimately linked to deep layer grafting of monomers, the method of the invention can simultaneously be used to harden the surface of the organic material over a thickness of one micrometer or less by creating an extreme surface layer of amorphous carbon. This amorphous carbon layer may be obtained by adjusting the implanted dose of ions in order to cross-link the organic material completely at the extreme surface and in order to cross-link it partially at a greater depth. The inventors have been able to show that this effect is particularly reinforced for multi-energy, multi-charged ions obtained from an electron cyclotron resonance (ECR) source. It appears that ions with lower charges, which are thus less energetic, participate in the total cross-linking of the extreme surface organic material (layer of amorphous carbon), while the ions with the higher charges, which are thus more energetic, participate in creating a deep layer reservoir of free radicals. It is thus possible to create two successive layers, an extreme surface layer that is completely cross-linked in the form of amorphous carbon, and the other, deeper layer that can subsequently be grafted with monomers.

This copolymerization is advantageously capable of supplying distinct pairs of improvements (hardness/hydrophobic nature; hardness/adhesion; hardness/antibacterial nature, etc.).

The method of the invention has the advantage of creating hydrophobic or antibacterial barriers that are thick and thus effective for long-term use or under severe conditions of use without modifying the bulk properties of the organic material. In fact, it might be possible to replace glass bottles with plastics bottles that, after treatment, have been rendered impermeable to ambient humidity. In another example, the method of the invention has the advantage of providing elastomers with excellent wettability (hydrophilic) properties combined with a surface hardness that is highly suitable for applying an aqueous based lacquer.

In various implementations, which may be combined together:
the dose of ions per unit area is in the range 10¹³ ions/cm² to 5×10¹⁷ ions/cm²;
the polymer material belongs to the family of polymers, elastomers, or resins;
the ion acceleration voltage is in the range 20 kV to 200 kV; and
the ions are produced by an ECR source that has the advantage of being compact and energy-saving and of producing multi-charged, multi-energy ions that favor the creation of a hybrid layer (amorphous carbon layer/graftable layer).

Thus, the present invention provides a method of surface treating a fluid dispenser device, said method comprising a step of modifying at least one surface to be treated of at least a portion of said device in contact with said fluid by ionic implantation using multi-charged and multi-energy ion beams, at least one surface to be treated of at least a portion of said device in contact with said fluid, said modified surface having properties limiting the appearance and/or proliferation of bacteria on said modified surface, said multi-charged ions being selected from helium (He), boron (B), carbon (C), nitrogen (N), oxygen (O), neon (Ne), argon (Ar), krypton (Kr), and xenon (Xe), ionic implantation being carried out to a depth of 0 μm to 3 μm.

Advantageous implementations are described in the dependent claims.

In particular, said method comprises a method of deep layer grafting monomers into an organic material, comprising two steps in succession:

a) a step of ionic bombardment by an ion beam:
to create a reservoir of free radicals in a layer (1) with a thickness e_{rad} in the range 20 nm to 3000 nm; and
to create a stabilizing layer (2) interposed between the surface and the reservoir of free radicals (1) with a thickness e_{stab} in the range 0 nm to 3000 nm;

the ions of the ion beam being selected from the ions of elements in the list constituted by helium (He), boron (B), carbon (C), nitrogen (N), oxygen (O), neon (Ne), argon (Ar), krypton (Kr), and xenon (Xe);

the ion acceleration voltage being greater than or equal to 10 kV or less than or equal to 1000 kV;

the treatment temperature of the organic material being less than or equal to its melting temperature;

the ion dose per unit area being selected so as to be in the range 10¹² ions/cm² to 10¹⁸ ions/cm² by using a measurement of the change over time of the surface resistivity of the organic material to identify the dose that induces the greatest jump step in the surface resistivity; and

b) a step of grafting monomers, consisting in diffusing monomers (M) through a stabilizing layer (2) from the surface towards the reservoir of free radicals (1) at a diffusion temperature T_{d}.

These characteristics and advantages, along with others of the present invention, become clearer from the following detailed description made in particular with reference to the accompanying drawings given by way of non-limiting example, and in which:

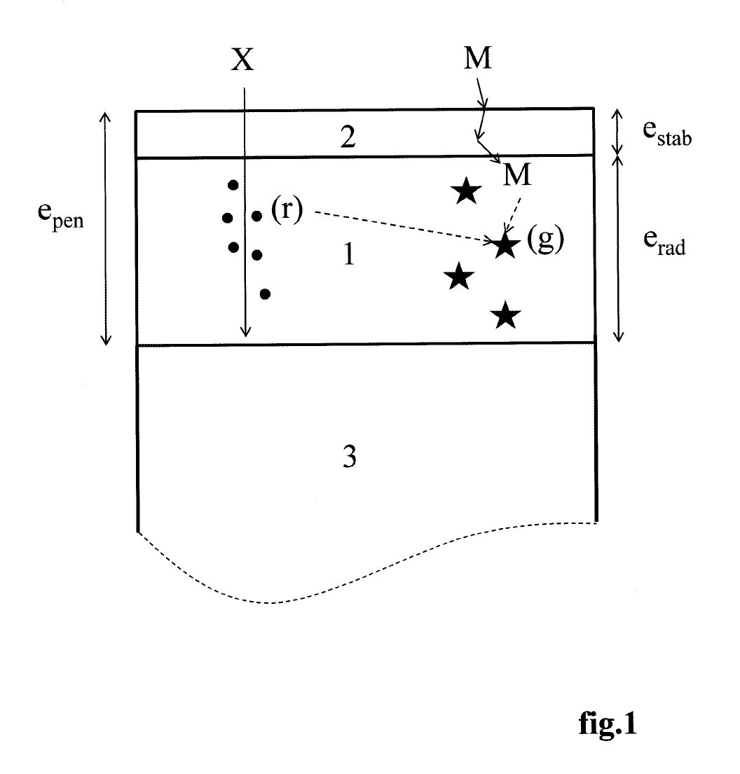

FIG. 1 shows the formation of a layer constituted by an extreme surface layer of amorphous carbon and a reservoir of free radicals located deeper down;

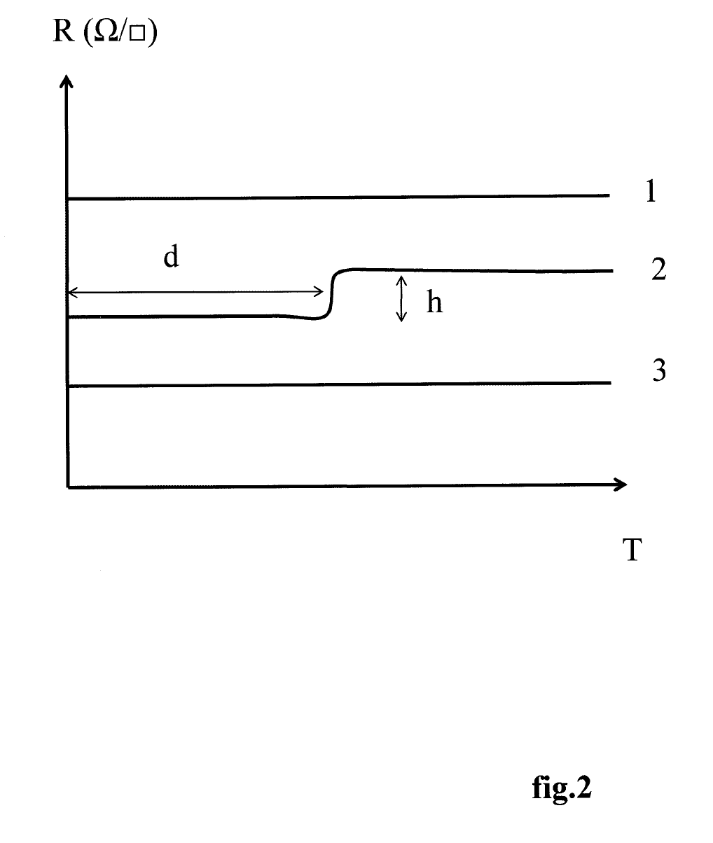

FIG. 2 shows the characteristic change with time of the surface resistivity of an organic material, untreated, treated by a method of the invention;

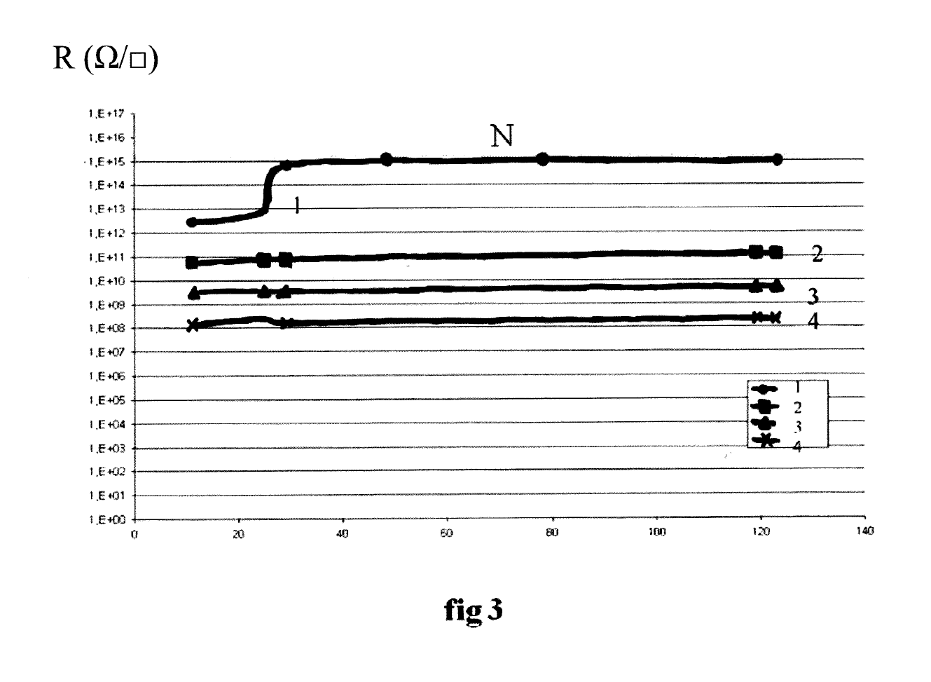

FIG. 3 shows experimentally the change in surface resistivity for different doses of a polycarbonate treated with He⁺, He²⁺ ions; the method recommended by the method of the invention can be used to identify a reservoir of free radicals that is particularly favorable to deep layer grafting; this identification consists in detecting a very marked resistive jump;

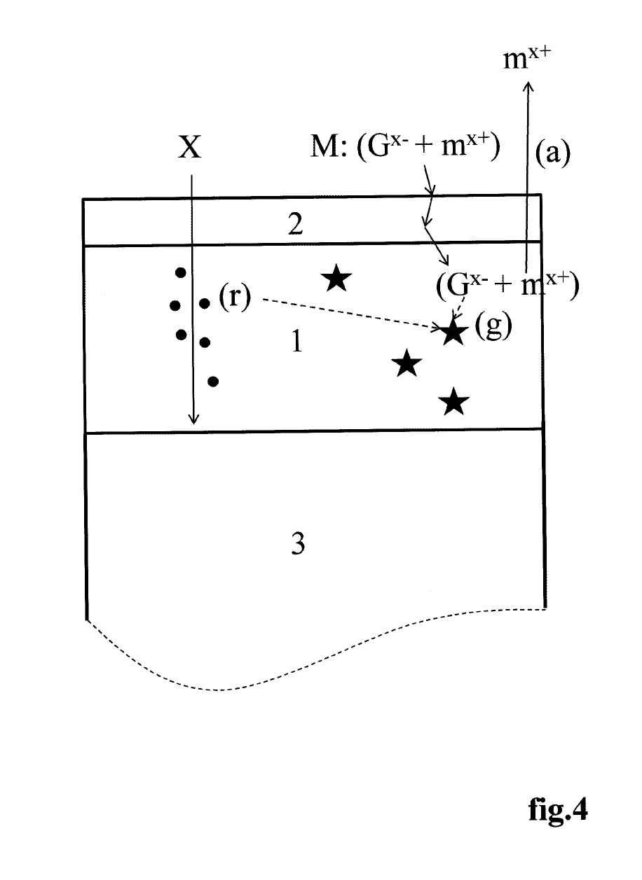

FIG. 4 shows a first embodiment of an antibacterial surface produced by the method of the invention;

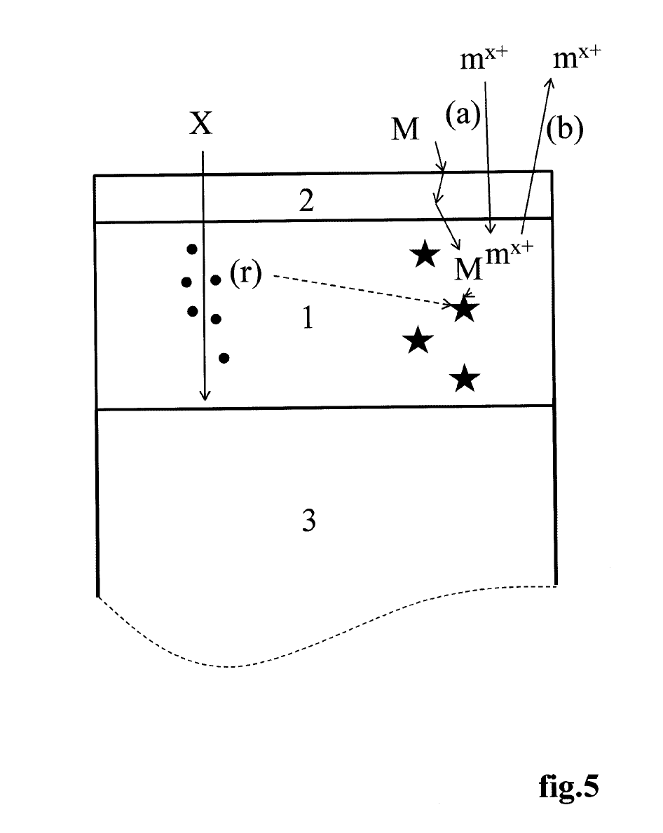

FIG. 5 shows another embodiment of an antibacterial surface produced by the method of the invention; and

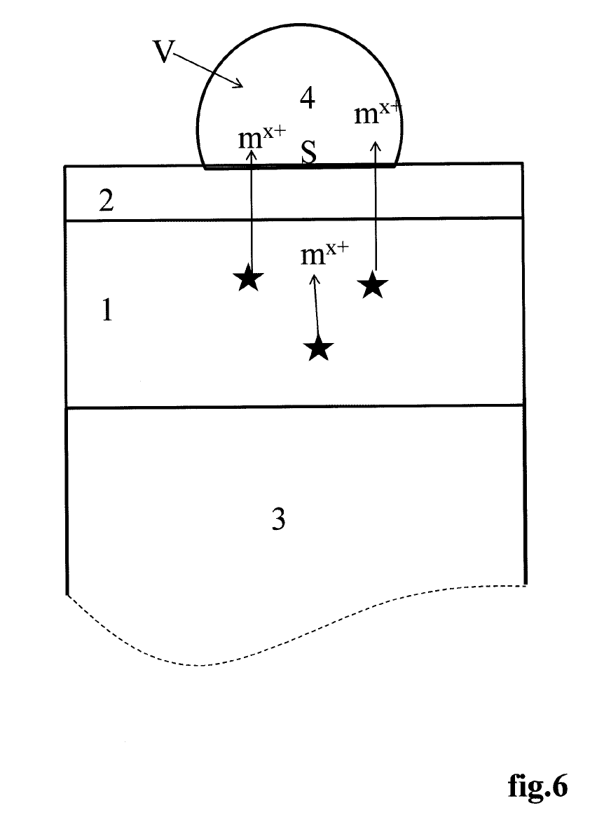

FIG. 6 shows the release of bactericidal ions into a fluid deposited on an antibacterial surface treated in accordance with the method of the invention.

In particular, the present invention provides for using a method similar to that described in document WO 2005/085491, which relates to an ionic implantation method, and more particularly to the use of a beam of multi-charged multi-energy ions, in order to structurally modify the surfaces of metallic materials over depths of about a μm in order to provide them with particular physical properties. That implantation method has in particular been used to treat parts produced from an aluminum alloy that are used as molds for the mass production of plastics material parts.

Surprisingly, that type of method has proved to be suitable for limiting the formation of a biofilm on the treated surfaces, and thus of limiting or even preventing the appearance and/or proliferation of bacteria on surfaces intended to come into contact with a pharmaceutical fluid in nasal or oral type dispenser devices to prevent interactions with said fluid. Such an application of that ionic implantation method has never been envisaged before. Thus, the description of that document WO 2005/085491 is incorporated in its entirety into the present description for the purposes of reference.

The surfaces to be treated may be made of metal, but also from synthetics such as polymers. The method is also applicable to materials such as glass or elastomers.

Put simply, the method consists of using one or more sources of ions such as an electron cyclotron resonance source, termed an ECR source. This ECR source can deliver an initial beam of multi-energy ions, for example with a total current of approximately 10 mA [milliamp] (all charges together) at an extraction voltage that may lie in the range 20 kV to 200 kV. The ECR source emits a beam of ions in the direction of adjustment means that focus and adjust the initial beam emitted by the ECR source into a beam of implantation ions that strike a part to be treated. Depending on the applications and the materials to be treated, the ions may be selected from helium, boron, carbon, nitrogen, oxygen, neon, argon, krypton, and xenon. Similarly, the maximum temperature of the part to be treated varies as a function of its nature. The typical implantation depth is in the range 0 μm to 3 μm, and depends not only on the surface to be treated but also on the properties that are to be improved.

The specificity of a source of ECR ions resides mainly in the fact that it delivers single- and multi-charged ions, meaning that multi-energy ions can be implanted simultaneously with the same extraction voltage. It is thus possible to obtain a properly distributed implantation profile over the whole of the treated thickness simultaneously. This improves the quality of the surface treatment.

Advantageously, the method is carried out in a chamber that is evacuated by means of a vacuum pump. This vacuum is intended to prevent interception of the beam by residual gases and to prevent contamination of the surface of the part by those same gases during implantation.

Advantageously, and as described in particular in document WO 2005/085491, the adjustment means mentioned above may comprise the following elements, from the ECR source to the part to be treated:
a mass spectrometer that can filter ions as a function of their charge and their mass. Such a spectrometer is optional, however, if a pure gas is injected, for example pure nitrogen gas (N₂). Thus, it is possible to recover all of the single- and multi-charged ions produced by the source in order to obtain a multi-energy ion beam;
one or more lenses to provide the ion beam with a predetermined shape, for example cylindrical, with a predetermined radius;
a profiler in order to analyze the intensity of the beam in a perpendicular sectional plane during the first implantation;
an intensity transformer in order to measure the intensity of the ion beam continuously without intercepting it. This instrument primarily detects any interruptions in the ion beam and makes it possible to record variations in the intensity of the beam during the treatment;
a shutter that may, for example, be a Faraday cage, to interrupt the trajectory of the ions at certain moments, for example during movement without treating the part.

In an advantageous implementation, the part to be treated is movable relative to the ECR source. The part may, for example, be mounted on a movable support that is used under the control of an N/C [numerically controlled] machine. The movement of the part to be treated is calculated as a function of the radius of the beam, the external and internal contours of the zones to be treated, the constant or variable movement speed as a function of the angle of the beam relative to the surface and the number of passes already carried out.

One possible implementation of the treatment method is as follows. The part to be treated is fixed on an appropriate support in a chamber, then the chamber is closed and an intense vacuum is set up using a vacuum pump. As soon as the vacuum conditions are reached, the ion beam is started up and adjusted. When said beam has been adjusted, the shutter is lifted and the N/C machine is actuated, which machine then controls the position and the speed of the movement of the part to be treated in front of the beam in one or more passes. When the number of passes required has been reached, the shutter is dropped to cut off the beam, beam production is halted, the vacuum is broken by opening the chamber to the ambient air, the cooling circuit is switched off if appropriate, and the treated part is removed from the chamber.

In order to reduce the temperature linked to the passage of the ion beam at a given point of the part to be treated, either the radius of the beam can be increased (to reduce the power per cm²), or the movement speed can be increased. If the part is too small to evacuate the heat associated with treatment by irradiation, either the power of the beam can be reduced (i.e. the treatment period is increased), or the cooling circuit is started up.

The method of the invention is non-polluting, in particular because it does not require chemicals. It is carried out dry, and so it avoids the relatively long drying periods associated with liquid treatment methods. It does not require there to be a sterile atmosphere outside the vacuum chamber; thus, it can be carried out anywhere. A particular advantage of this method is that it can be integrated into the assembly line for the fluid dispenser device and operated continuously in that line. This integration of the treatment method in the production tool simplifies and speeds up the manufacturing and assembly process as a whole and thus has a positive impact on its cost.

FIGS. 1 to 6 show advantageous implementations of the invention.

In the implementational examples of the present invention, samples of polycarbonate were studied for treatment with helium ions emitted by an ECR source.

The ion beam with an current of 5 mA comprised He and He²⁺ ions with a distribution (He⁺/He²⁺)=10; the extraction and acceleration voltage was 35 kV; the He energy was 35 keV [kilo electron volt] and that of He²⁺ was 90 keV.

The sample to be treated was moved relative to the beam at a movement rate of 40 mm/s [millimeters per second] with a lateral advance on each return of 1 mm. In order to reach the necessary dose, the treatment was carried out in several passes.

The change with time of the surface resistivity of the polycarbonate was carried out in application of IEC standard 60093, which recommends measuring, after one minute, the electrical resistance existing between two electrodes, one constituted by a disk with a diameter d, the other by a ring centered on the disk and with an internal radius D. These electrodes were placed on the surface of the polycarbonate and subjected to a voltage of 100 V [volt]. D was equal to 15 mm and d was equal to 6 mm. Measurement of the surface resistivity was only possible for values of less than 10¹⁵Ω/□.

In accordance with a first implementational example of the present invention, samples of PP (polypropylene) were used to study grafting with acrylic acid for a treatment with helium ions emitted by a ECR source.

The ion beam with an current of 300 μA [microamp] comprised He and He²⁺ ions with a distribution (He⁺/He²⁺)=10; the extraction and acceleration voltage was 35 kV; the He energy was 35 keV and that of He²⁺ was 90 keV. The sample to be treated was moved relative to the beam at a movement rate of 80 mm/s with a lateral advance on each return of 3 mm. In order to reach the necessary dose, the treatment was carried out in several passes.

The samples of polypropylene PP were bombarded with different doses corresponding to 2×10¹⁴ ions/cm² [ions per square centimeter], 5×10¹⁴ ions/cm², and 10¹⁵ ions/cm².

A single grafting condition was used: immersion for 24 h [hour] in an acrylic acid solution (CH₂═CH—COOH) dosed in an amount of 10% by weight, maintained at 40° C.

Measurements of the contact angles of droplets allowed the modification in the wettability of the surface following grafting to be validated, characterized by the change from a hydrophobic behavior to a hydrophilic behavior.

These results are summarized in Table 1.

TABLE 1

| Sample | Contact angle (°) |
|---|---|
| Untreated | 76° |
| Treated 2 × 10¹⁴ ions/cm² + immersion | 74° |
| Treated 5 × 10¹⁴ ions/cm² + immersion | 64° |
| Treated 10¹⁵ ions/cm² + immersion | 66° |

The behavior of the PP changed—the untreated sample had somewhat hydrophobic behavior (contact angle) 76°, while the behavior of the treated samples tended somewhat towards being hydrophilic (contact angle smaller, at 64°). It can be seen that the hydrophilic behavior was substantially improved for doses in the range 5×10¹⁴ ions/cm² to 10¹⁵ ions/cm². It can be seen that FTIR [Fourier transform infra-red] analysis of the PP treated with He indicated a dose of the same order of magnitude as those observed by measuring the surface conductivity on polycarbonate PC treated with He.

In a second implementational example of the invention, samples of polypropylene were used for grafting studies with acrylic acid for a treatment with nitrogen ions emitted by an ECR source.

The ion beam with an current of 300 μA comprised N⁺, N²⁺, and N³⁺ ions, with respective distributions of 60%, 40%, and 10%; the extraction and acceleration voltage was 35 keV; the energy of N⁺ was 35 keV, that of N²⁺ was 90 keV, and that of N³⁺ was 105 keV.

The PP samples were bombarded with different doses at 2×10¹⁴ ions/cm², 5×10¹⁴ ions/cm², 10¹⁵ ions/cm² and 5×10¹⁵ ions/cm².

The sample to be treated was moved relative to the beam at a movement rate of 80 mm/s with a lateral advance on each return of 3 mm. To obtain the required dose . . . .

Two grafting conditions were employed; the results are summarized in Table 2:
an acrylic acid solution (CH₂═CH—COOH), 10% by volume, maintained at 40° C.;
an acrylic acid solution (CH2=CH—COOH), 10% by volume, maintained at 60° C.

TABLE 2

Contact angle (°)

| | Grafting | Grafting |
|---|---|---|
| Sample | at 40° C. | at 60° C. |
| Untreated | 82° | 82° |
| Untreated immersed | 81° | 80° |
| Treated 2.10¹⁴ ions/cm² and immersed | 58° | 60° |
| Treated 5.10¹⁴ ions/cm² and immersed | 70° | 68° |
| Treated 10¹⁵ ions/cm² and immersed | 75° | 70° |
| Treated 5.10¹⁵ ions/cm² and immersed | 65° | 75° |

It should be observed that grafting did indeed occur for all of the samples treated and immersed in an acrylic acid solution at 40° C. or 60° C. Untreated samples immersed in the grafting solution did not exhibit any changes in terms of wettability, which reveals that ionic bombardment under the conditions recommended by the method of the invention is clearly the origin of the grafting. For doses of less than 10¹⁵ ions/cm², the contact angles appear to be relatively comparable, plus or minus 2°. For doses of 10¹⁵ ions/cm², 5×10¹⁵ ions/cm², an inverse effect was observed: for a dose of 10¹⁵ ions/cm² and immersion at 60° C., the contact angle of the droplet of water was smaller than for immersion at 40° C. (70°<75°); for a dose of 5×10¹⁵ ions/cm² and immersion at 60° C., the contact angle of the droplet of water was greater than for immersion at 40° C. (65°<75°). Without wishing to be bound by any particular scientific theory, it may be considered that the stabilizing layer is thinner at lower doses (2×10¹⁴ ions/cm², 5×10¹⁴ ions/cm²). Acrylic acid molecules pass through this layer in a relatively short time, both at 40° C. and at 60° C., before the onset of self-combination of free radicals can occur, even in the core of the reservoir created by the ionic bombardment. Grafting of the acrylic acid with the free radicals from the reservoir is then total. The contact angle has a tendency to increase at the same time as the thickness of the stabilizing layer that separates the reservoir of free radicals from the surface. When the dose is increased, in other words when the thickness of the stabilizing layer reaches a certain threshold, the temperature acts somewhat in favor of self-combination of free radicals, to the detriment of grafting. Thus, the acrylic acid has no more time to reach the reservoir of free radicals for grafting therein. In fact, the contact angle of the droplet at 60° C. is higher than at 40° C. The inventors have been able to conclude that it is then preferable to graft at 40° C. or even at ambient temperature rather than at 60° C.

Grafting of the acrylic acid was also confirmed by a more refined mode of investigation, FTIR analysis. The IR [infrared] spectrum of the samples at different doses showed an absorption peak at about 1710 cm⁻¹ [per centimeter](absorption peak of carbonyl group: C═O); and the appearance of an absorption peak at approximately 3200 cm⁻¹ (absorption peak of the hydroxyl group (OH)). These two functional groups, carbonyl and hydroxyl, are absent from PP and thus could only have come from the acrylic acid.

Tables 3 and 4 below show the results obtained at respective immersion temperatures of 40° C. and 60° C.:

TABLE 3

| Dose + acrylic acid | Transmittance at | Transmittance at |
|---|---|---|
| immersion, 40° C. | 1710 cm⁻¹ | 3200 cm⁻¹ |
| Untreated | 97.5% | 97.5% |
| 10¹⁴ | 95% | 96 |
| 5 × 10¹⁴ | 86% | 92% |
| 10¹⁵ | 87% | 88% |
| 5 × 10¹⁵ | 89% | 92% |

It can be seen that the optimum dose for which the absorption peak (reduction of transmittance) was the highest was located at about 5×10¹⁴ ions/cm².

TABLE 4

| Dose + acrylic acid | Transmittance at | Transmittance at |
|---|---|---|
| immersion, 60° C. | 1710 cm⁻¹ | 3200 cm⁻¹ |
| Untreated | 97.5% | 97.5% |
| 10¹⁴ | 95% | 92% |
| 5 × 10¹⁴ | 89% | 89.5% |
| 10¹⁵ | 88.5% | 88.5% |
| 5 × 10¹⁵ | 90% | 89% |

It can be seen that for immersion at 60° C., the optimized dose for which the absorption peak (reduction in transmittance) was the highest was located at about 10¹⁵ ions/cm². This is true both for the CO groups (1710 cm⁻¹) and for the OH groups (3200 cm⁻¹). The absorption peaks were lower at 60° C. than at 40° C., thus confirming that a portion of the free radicals had partially self-combined under the effect of the temperature.

The inventors have been able to show, on the basis of preliminary tests and extrapolation, that it is possible, for any type of ion with a given energy, to calculate the dose corresponding to the highest resistive jump step, using the results obtained under the same conditions for another type of ion with a different energy. The relationship is as follows:

N1×Eᵢₒₙ(E1)=N2×Eᵢₒₙ(E2)

where:
N1 is the dose (the number of ions per unit area) associated with the highest resistive jump step of an ion (1);
E1 the energy of the ion (1);
Eᵢₒₙ(E1) is the ionization energy of the ion (1) at the start of the trajectory in the polymer. This energy corresponds to the energy released by the ion (1) to the electrons of the polymer in the form of ionization;
N2 is the dose (the number of ions per unit area) associated with the highest resistive jump step of an ion (2);
E2 the energy of the ion (2);
Eᵢₒₙ(E2) is the ionization energy of the ion (2) at the start of the trajectory in the polymer.

This ionization energy is a function of the nature and of the energy of the ion and of the nature of the polymer. Methods and data for carrying out these calculations are in particular disclosed in the publications “The Stopping and Range of Ions in Matter” by J. F. Ziegler, volumes 2-6, Pergamon Press, 1977-1985, “The Stopping and Range of Ions in Solids” by J. F. Ziegler, J. P. Biersack and U. Littmark, Pergamon Press, New York, 1985 and J. P. Biersack and L. Haggmark, Nucl. Instr. and Meth., vol. 174, 257, 1980.

Further, software has been developed and sold for facilitating or carrying out such calculations, such as, for example the software supplied with the names “SRIM” (“The Stopping and Range of Ions in Matter”) and “TRIM” (“The Transport of Ions in Matter”), developed in particular by James F. Ziegler.

As an example, the following correspondence table, Table 5, is obtained for PP (polypropylene):

TABLE 5

| Type of ion | Energy(KeV) | Eᵢₒₙ(eV/Å) | N(ion/cm²) |
|---|---|---|---|
| He | 35 | 10 | 10¹⁵ |
| N | 50 | 20 | 5 × 10¹⁴ |
| Ar | 40 | 20 | 5 × 10¹⁴ |

The first row of the table reiterates known experimental data: He is the type of ion employed, with the energy of the ion used being 35 keV; the ionization energy of the helium at the start of its trajectory in the PP is 10 eV/Å [electron volts per ångström] (provided by TRIM&SRIM). The 10¹⁵ ions/cm² dose is the dose identified by the experiment corresponding to the resistive jump step of PC, knowing that PC has an ionization energy of (9.5 eV/Å), almost identical to that of PP.

In the second row, the nature of the ion is known, N, its energy is 50 keV, and its ionization energy, estimated by TRIM&SRIM, is 20 eV/Å. The dose corresponding to the highest resistive jump step is deduced by applying the relationship N=(10×10¹⁵)/20=5×10¹⁴ ions/cm². This dose is relatively close to that deduced by FTIR for PP (see Table 3).

The third row constitutes another example of grafting with argon that has to be validated. In this row, a dose corresponding to the highest resistive jump step is deduced that is about 5×10¹⁴ ions/cm², in other words relatively close to that obtained with the nitrogen beam

The method of the invention is characterized by the following advantages:
creation of a reservoir of free radicals of optimized capacity accessible to the monomers of the solution. The other techniques of grafting with plasmas, electron beams and gamma radiation have the disadvantage of creating free radicals at depth, which are inaccessible to the monomers and which degrade the bulk properties of the material;
conservation of this reservoir of free radicals at ambient temperature and over a long period under ambient conditions prior to grafting. The treated polymer can be grafted several days after bombardment. This is not possible with the other plasma grafting techniques that use electron beams and gamma radiation. Those techniques do not create a stabilizing layer; the treated polymers have to be kept in the dark and at low temperatures, below −20° C., prior to grafting; and
saturation of the grafted layer with monomer.

Two implementations exist for creating a grafted layer storing and releasing ions known for their bactericidal action such as, for example, silver ions (Ag⁺), copper ions (Cu²⁺), or zinc ions (Zn²⁺). The choice of implementation depends essentially on cost: examples of modes that may be mentioned are the cost of the monomers to be grafted, and the number of operations to be carried out to obtain the antibacterial effect (immersion in one or two solutions).

The first implementation consists in bombarding the polymer with ions then immersing it in a solution of metal salts such as, for example, in a metal acrylate solution (CH₂═CH—COO⁻+(M⁺)) or (2CH₂═CH—COO⁻+(M²⁺)). Examples that may be used are copper acrylate, silver acrylate, or zinc acrylate. Copper acrylate is known to have biocidal properties; it is in particular used in anti-fouling paints for boat hulls. The aim is to prevent the marine organism from attaching itself. In maritime legislation, for environmental impact reasons, copper leaching must not exceed 20 micrograms per day per cm² in the first 14 days of contact with sea water. The principle of antibacterial grafting is as follows: the acrylate reacts with the free radicals to bond to the substrate, bringing with it the bactericidal metal ion weakly attached to the CO²⁻ terminus. The metal ion may then be released to the outside in order to exert its bactericidal action.

The second implementation comprises two steps:
a first step in which the polymer is bombarded and in which the polymer is grafted with monomers having the capability of establishing weak bonds (chelation type) with metal ions. An example that may be mentioned is acrylic acid: the non-binding electron pairs of the hydroxyl group of acrylic acid are capable of trapping metal ions by chelation;
a second step in which the grafted layer is loaded with bactericidal metal ions by immersing it in a solution containing those same ions. Once stored in the grafted layer, these bactericidal metal ions are liberated as soon as they come into contact with a fluid deposited on the grafted layer. The bactericidal metal ions diffuse into the fluid and exert their bactericidal action as soon as their concentration exceeds a bactericidal concentration threshold specific to the nature of the ion. For the silver ion (Ag⁺), it is known that a concentration threshold of 20 ppm [parts per million], in other words 20 mg per kg [kilogram], is highly bactericidal to bacteria such as Staphylococcus aureus (Staphylococcus aureus resistant to methicillin or MRSA), Enterococcus faecium (Enterococcus resistant to vancomycin or VRE), Enterococcus fecalis Burkholderia cepacia Alcaligenes sp. Pseudomonas eruginosa, or Klebsiella pneumoniae Pseudomonas sp. Acinetobacter sp. itrobacter koseri. For 1 cm³ of fluid deposited on one cm² of a layer grafted with acrylic acid and loaded with Ag⁺ ions, the equivalent of 20 μg/cm² of Ag⁺ ions should be released in order to have an effective bactericidal effect. For copper, the bactericidal concentration threshold is approximately 10 ppm, in other words 10 μg/cm³ [microgram per cubic centimeter]. There are many solutions for loading the grafted layer with bactericidal ions. Examples that may be mentioned are solutions of copper sulfate (CuSO₄), silver nitrate (AgNO₃) or silver chloride.

In both implementations, the grafted antibacterial layer acts as a bactericidal ion exchanger, and its features may advantageously be adjusted in order to:
guarantee an effective antibacterial effect over the period:
   exceeding a bactericidal concentration threshold; and
   maintaining this effect over a significant period having regard to the envisaged application;
limit the impact of the treatment on the environment or on health; and
reduce implementation costs, for example by reducing the quantity of precious metal from which the Ag⁺ ions are obtained.

The inventors have developed a model for grafting and storing metal ions that can be used to establish a useful formula for making predictions about the metal ion storage capacity as a function of the bombardment parameters.

This model is based firstly on the specific nature of the grafted layer, as could be observed experimentally (reservoir of free radicals flush with the surface and protected by a stabilizing layer of amorphous carbon), and secondly on steric hindrance considerations, the effect of which is to limit grafting independently of the number of free radicals present.

This model integrates the following points:
for a dose where the highest resistive jump step is produced:
   the monomers constituting the polymer have an even chance of having a number of free radicals that decreases from the extreme surface to the end of the trajectory of the ion; and
   these free radicals are preserved by the stabilizing layer. They are constant in number until the moment of grafting;
grafting of the monomers to be grafted is limited by the size of the monomers constituting the polymer. When the monomers to be grafted are of a size that is comparable with the monomers constituting the polymer, it is not possible to graft more than one monomer to a monomer constituting the polymer. The grafting rule is as follows: the number of monomers Ng that can be grafted onto a monomer constituting the polymer is in the range (Lp/Lg) to (Lp/Lg)−1 if Lp>Lg, where Lg is the length of the monomer to be grafted and Lp is the length of the monomer constituting the polymer; if Lp<Lg, N_{G} is equal to Lp/(Lg+1); and
the grafted monomers establish weak bonds with the bactericidal metal ions. The number of bactericidal ions bonded to a grafted monomer can be deduced by considering its chemical composition. As an example, a grafted monomer such as acrylic acid can accommodate only a single Ag⁺ or Cu²⁺ ion by chelation; it becomes bonded to one of the two non-bonding doublets of the hydroxyl group (OH).

From these assumptions, the inventors have been able to establish the following formula:

Nᵢₒₙ=(1/2)·6.02×10²³·Eₚ·(ρ/Mₘₒₗ)·K·A

where:
Nᵢₒₙ represents the number of bactericidal ions that can be stored and released per unit area;
1/2: represents a corrective factor that takes account of the linear decrease in free radicals from the extreme surface to the end of the trajectory of the ion;
Eₚ: represents the bombarded and grafted thickness. This thickness is a function of the energy of the ion, its nature and the nature of the polymer. It can be calculated using TRIM&SRIM software;
ρ: represents the bulk density of the polymer;
Mₘₒₗ: represents the molar weight of the monomer constituting the polymer;
K: represents the mean number of monomers grafted per monomer constituting the polymer;
   if Lp>Lg, K is in the range Lp/Lg to Lp/Lg−1, and the mean value is taken:

K=(2×(Lp/Lg)−1)/2.
if Lp<Lg, K=Lp/(Lg+1); and
this number K may be refined, corrected or even deduced directly from experiment. To this end, a technique known as RBS (Rutherford Back Scattering) is used that can spray a surface layer by layer to deduce the composition of the sprayed elements by mass spectrometry. It is possible, for example, to evaluate the number of oxygen atoms per unit area attributable to the presence of grafted acrylic acid and to deduce the number of acrylic acid monomers per unit area knowing firstly that two oxygen atoms are necessary per acrylic acid monomer and secondly that these atoms cannot originate from the polymer. Thus, K can be corrected by applying to it an experimental corrective factor; and
A: the number of (storable and releasable) metal ions bonded per grafted monomer. A can be deduced from the chemical composition of the grafted monomer. As an example, for a silver acrylate monomer, there is only one single silver ion (Ag⁺) per grafted acrylate monomer: A=1. In another example, for an acrylic acid monomer, only one single silver ion (Ag⁺) can be bonded by chelation onto the single hydroxyl group (OH): A=1. In this model, it is assumed that all of the storable metal ions are completely releasable. This number A may be corrected or even deduced from extremely sensitive measurements of the order of one μg [microgram], carried out using a microbalance. To this end, the difference in weight, expressed in μg/cm², of a grafted polymer must be evaluated before and after immersion in a solution of bactericidal metal ions, or of a grafted polymer loaded with bactericidal metal ions before and after immersion in deionized water. Thus, A can be corrected by applying to it an experimental corrective factor.

The charge per unit area Cs, defined as the mass of bactericidal metal ions stored and releasable per unit area, can be deduced:

CS=(Nᵢₒₙ/Nₐₜ)×ρ

where
Nᵢₒₙ represents the number of stored and releasable bactericidal metal ions per unit area;
ρ represents the bulk density of the metal from which the bactericidal metal ions are produced; and
Nₐₜ represents the number of atoms per unit volume of metal from which the bactericidal metal ions are produced.

Using this formula, it is possible to obtain estimates of the number of ions that are stored in and can be released from a grafted layer of polymer, to evaluate and predict the bactericidal effect over a given volume of fluid.

Consideration is given, for example, to a PP (polypropylene) bombarded with three types of ions, He, N, Ar with the same energy, with different doses calculated to obtain a stabilizing layer and an optimized reservoir of free radicals (highest resistive jump step), which is then grafted with acrylic acid, and which is finally immersed in a solution of silver or copper. The parameters of the formula are initialized with the following values:
bulk density of polymer PP: ρ=0.9 g/cm³ [gram per cubic centimeter];
molar weight of monomer of polymer: Mₘₒₗ=42 g [gram] (monomer: CH₂═CH—CH₃); and
deduction of number of monomers grafted per monomer constituting the polymer: K=0.5; the size of the monomer to be grafted (CH₂═CH—COOH) is substantially comparable to that of the monomer of the polymer (CH₂═CH—CH₃);
deduction of number of Ag⁺ or Cu²⁺ metal ions bonded per grafted monomer: A=1.

The calculation of the surface loading of bactericidal metal ions that are stored and released, combined with knowledge of the bactericidal concentration thresholds, means that it is possible to predict the volume of fluid that can effectively be provided with a bactericidal action.

As an example, for fixed bombardment and grafting parameters, followed by immersion in a solution of Ag⁺ ions, the surface loading estimates shown in Table 6 are obtained:

TABLE 6

| | | | | Surface |
|---|---|---|---|---|
| | | | Nᵢₒₙ, | loading |
| Type of | Energy | Thickness | releasable Ag⁺ | Ag+ |
| ion | (keV) | (μm) | (ions/cm²) | (μg/cm²) |
| He | 35 | 0.7 | 2.1 × 10¹⁷ | 37.8 |
| N | 35 | 0.25 | 7.25 × 10¹⁶ | 12.95 |
| Ar | 35 | 0.12 | 3.6 × 10¹⁶ | 6.48 |

It can be seen that the surface loading of Ag⁺ ions stored and releasable by a layer bombarded with He, grafted with acrylic acid and then immersed in a solution of Ag⁺ ions, has highly bactericidal characteristics when treating a volume of fluid of approximately 1.9 cm³ (the bactericidal concentration of Ag⁺ is 20 ppm, in other words 20 μg/cm³). For bombardment with N, the surface loading of stored and releasable Ag⁺ ions is lower, but is still effective for treating 0.65 cm³. For bombardment with Ar, the surface loading of stored and releasable Ag⁺ ions can be used to effectively treat a film of fluid 2 mm thick. Thus, the bactericidal properties of a surface treated in accordance with the method of the invention can be modulated as a function of the envisaged applications whether this applies to a drop of fluid, or a film of fluid, etc.

For fixed bombardment and grafting parameters followed by immersion in a solution of Cu²⁺ ions, the surface loading estimates shown in Table 7 are obtained:

TABLE 7

| | | | Nᵢₒₙ, | Surface |
|---|---|---|---|---|
| | Energy | Thickness | releasable Cu²⁺ | loading Cu²⁺ |
| Type of ion | (keV) | (μm) | (ions/cm²) | (μg/cm²) |
| He | 35 | 0.7 | 2.1 × 10¹⁷ | 21 |
| N | 35 | 0.25 | 7.25 × 10¹⁶ | 7.25 |
| Ar | 35 | 0.12 | 3.6 × 10¹⁶ | 3.6 |

In the same manner as for the Ag⁺ ions, it can be seen that the load of Cu²⁺ ions stored and releasable by a layer bombarded with He, grafted with acrylic acid, and then immersed in a solution of Cu²⁺ ions has highly bactericidal characteristics for treating a volume of fluid of approximately 2.1 cm³ (the bactericidal concentration threshold for Cu²⁺ is 10 ppm, in other words equal to 10 μg/cm³).

Another approach for a given ion type consists of adjusting the energy of the ion, in other words of adapting the depth of the thickness of the treatment Ep, to store and release a load of bactericidal metal ions that is sufficient to exceed the bactericidal concentration threshold (specific to the bactericidal metal ions) into a fluid with a given volume and contact surface. The load of metal ions that can be released into the fluid is proportional to the contact area of the fluid with the bactericidal surface.

As an example, for PP bombarded with a single type of nitrogen ion with three possible energies of 35 keV, 50 keV, 70 keV and grafted with acrylic acid, and then immersed in a solution of Cu²⁺ copper, the respective surface loadings of stored and releasable Cu²⁺ ions can be estimated with the aim of identifying the energy that can exceed a bactericidal concentration threshold equal to (10 μg/cm³) in a volume of fluid of 1 cm³ with a contact surface of 1 cm². The estimates of the surface loading are shown in Table 8:

TABLE 8

| | | | Nᵢₒₙ, | Cu²⁺ |
|---|---|---|---|---|
| Type of | Energy | Thickness | releasable Cu²⁺ | loading |
| ion | (keV) | (μm) | (ions/cm²) | (μg/cm²) |
| N | 35 | 0.25 | 7.25 × 10¹⁶ | 7.25 |
| N | 50 | 0.3 | 8.7 × 10¹⁶ | 8.7 |
| N | 70 | 0.4 | 11.6 × 10¹⁶ | 11.6 |

It can be deduced from this table that an energy of approximately 60 keV is required to create a sufficient bactericidal charge of 10 μg/cm² in order to treat 1 cm³ extending over 1 cm².

The method of the invention can be used to determine the ionic bombardment parameters for creating a grafted layer that has optimized characteristics (hydrophilic, hydrophobic, antibacterial, metal ion exchanger), leaving open the many implementational conditions: nature, temperature, and concentration of solutions of monomers to be grafted, metal ions to be loaded into the grafted layer. These implementational conditions act only on the chemical kinetics (speed of obtaining a result). These conditions have little or no effect on the result per se. These implementational conditions are within the remit of the industrialist who should adjust them during preliminary tests to match then to a production rate, economic costs, etc. As a general rule, the inventors recommend preliminary tests with solutions that do not exceed 40° C. in order to avoid the free radicals combining before grafting, and concentrations of less than 10% by volume in order to produce good homogeneity of the solution during grafting or during loading with bactericidal ions.

The spectra of action of the Ag⁺ and Cu²⁺ ions on the bacterial or fungal agents overlap in part, the first being more effective, or even not at all compared with the second in treating a bacterium or fungus. In several embodiments of a bactericidal surface, the spectrum of action of these ions can be broadened, for example by immersing a PP bombarded and grafted with acrylic acid in bactericidal Cu²⁺ and/or Ag⁺ metal ion solutions simultaneously or sequentially in one direction or another with the aim of obtaining, in the end, specific stored proportions of bactericidal metal ions, for example storing bactericidal metal ions constituted by 70% silver ions (Ag⁺) and 30% copper ions (Cu²⁺).

FIG. 1 shows the structure of a thickness of organic material produced by ionic bombardment in accordance with the method of the invention. When an ion (X) penetrates the organic material over a thickness eₚₑₙ, it produces free radicals during its passage. Beyond that, in the layer (3), the organic material retains its original properties. The extreme surface free radicals combine very rapidly together in a zone (2) to preferentially create, by cross-linking, a stable layer essentially constituted by amorphous carbon in a thickness e_{stab}. The free radicals located deeper down constitute a more reactive layer (1) with thickness e_{rad}, which are good for grafting (1). This layer (1) is termed the free radical reservoir (r). These free radicals are available to participate in subsequent grafting of monomers (M). It should be noted that the zone (2) might not exist if the dose of energy released by the incident ions at the extreme surface is not sufficient to cause complete cross-linking at the extreme surface. The stable layer (2) then does not exist; the layer of organic material accessible to incident ions (X) over a thickness combines with the reservoir of free radicals (1); in other words eₚₑₙ, is equal to e_{rad}. The reservoir of free radicals (1) is then in direct contact with the outside. The grafting carried out in a second step consists in diffusing a monomer (M) from the surface of the organic material towards the free radical reservoir (1) through a stabilized layer of amorphous carbon (2) that might not exist, as seen above. After diffusion into the reservoir of free radicals (1), the monomer (M) reacts with (r) to produce a grafted chemical compound (g) with the hydrophilic, hydrophobic, or antibacterial properties of the original monomer. The thickness e_{rad} is in the range 20 nm to 3000 nm, corresponding to the minimum and maximum trajectories of the incident ions, taking their energies into account. The thickness e_{stab} varies as a function of the treated thickness and is completely, little, or not cross-linked into the form of amorphous carbon between 3000 nm and 0 nm. The rule is that eₚₑₙ=e_{rad}+e_{stab}.

FIG. 2 shows the changes with time of the surface resistivity in ambient medium:

1) untreated organic material, which by nature is highly insulating (curve 1);

2) the same organic material treated using the method of the invention to provide it with an optimized reservoir of optimum free radicals that are readily identified by a resistive jump step (h) that occurs after a period (d) (curve 2). The delay corresponds to the time for ambient oxygen to diffuse through the layer of amorphous carbon (1). The delay is longer when this layer is thicker; and

3) the same organic material treated with a higher dose producing a thick amorphous carbon layer by cross-linking, which has low resistivity and which is extremely stable over time (curve 3).

The abscissa (T) represents time and the ordinate (R) represents the surface resistivity, expressed as Ω/□.

FIG. 3 shows the experimental change in surface resistivity of a polycarbonate as a function of time for different doses of helium equal to 10¹⁵ ions/cm² (curve 1), 2.5×10¹⁵ ions/cm² (curve 2), 5×10¹⁵ ions/cm² (curve 3), 2.5×10¹⁶ ions/cm² (curve 4). The resistivity measurement was carried out in accordance with IEC standard 60093. The resistivity measurement method employed did not allow resistivities of more than 10¹⁵Ω/□ to be measured. This is represented by zone N, located on the graph at above 10¹⁵Ω/□. The abscissa corresponds to the time, expressed in days, between the sample being treated and the its surface resistivity being measured. The ordinate corresponds to the measurement of the surface resistivity, expressed in Ω/□. For curve 1, associated with a dose of 10¹⁵ ions/cm², it can be seen that after treatment using the method of the invention, the surface resistivity reduces over one month by approximately 3 orders of magnitude, changing from 1.5×10¹⁶Ω/□ to 5×10¹²Ω/□, then suddenly regains its original value at about 1.5×10¹⁶Ω/□. A resistive step of 3 orders of magnitude can clearly be seen at about 30 days in the form of a step. This resistive step reveals the existence of a reservoir of deep layer free radicals that combine very rapidly with oxygen of the air. Without wishing to be bound by any particular scientific theory, this period of 30 days should represent the time taken for ambient oxygen to diffuse through a layer of relatively amorphous carbon located at the extreme surface interposed between the ambient medium and the reservoir of free radicals. For curves 2, 3 and 4 associated with doses of 2.5×10¹⁵ ions/cm², 5×10¹⁵ ions/cm², 2.5×10¹⁶ ions/cm², it can be seen that the surface resistivity remains constant for more than 120 days at about values of 10¹¹Ω/□ to 5×10⁹Ω/□, and 1.5×10⁹Ω/□. Without wishing to be bound by any specific scientific theory, it is assumed that the layers obtained with doses of more than 2.5×10¹⁵ ions/cm² are extremely stable, because they include very few free radicals. These layers are the fruit of complete cross-linking, resulting in the formation of a layer of amorphous carbon atoms. The surface resistivity measurement is an effective method of identifying the dose, in this example 10¹⁵ ions/cm², which allows optimized deep layer grafting of monomers. The method of the invention in general recommends identifying the dose at which the resistive jump step is the greatest. To accelerate this identification process, the temperature of the samples may be increased so as to increase the rate of diffusion of the ambient oxygen.

FIG. 4 shows an implementation for creating an antibacterial layer, consisting in bombarding the polymer with ions (X) in order to create a reservoir of free radicals (1) where grafting of the monomer (M) is carried out by immersion in a single solution of monomers (M). The monomer (M) comprises a graftable portion (G^{x-}) and a bactericidal metal ion (m^{x+}) weakly bonded to (G^{x-}). Once grafting has been carried out, the stored bactericidal metal ion (m^{x+}) can be released in a step (a) through the stabilizing layer (2) to exert its bactericidal action. An example that may be used is silver acrylate, (CH₂═CH—COO⁻+Ag⁺).

FIG. 5 shows a second implementation for creating an antibacterial layer, comprising a first step in which the polymer is bombarded with ions (X) to create a reservoir of free radicals (1) where grafting of the monomer (M) is carried out by immersion in a solution containing these monomers (M), then a second step where the grafted monomer is immersed in a solution of bactericidal metal ions (m^{x+}) that in a sub-step (a) diffuse through the stabilizing layer (2) to be stored and weakly bonded (chelation) to the monomers (M) of the layer (1) so as to be able to diffuse again in a sub-step (b) through the stabilizing layer (2) to exert their bactericidal action. An example that can be mentioned is grafting in a solution of acrylic acid and storage of Cu²⁺ ions deriving from immersion in a solution of copper sulfate.

FIG. 6 shows the release of bactericidal metal ions (m^{x+}) stored in the grafted layer (1) into the fluid deposited on the surface of the layer (2) in the form of a drop (4). The antibacterial effect is effective when the quantity of metal ions diffused into the fluid exceeds a threshold bactericidal concentration that is estimated to be 20 ppm (20 μg/cm³) for Ag⁺ ions, 10 ppm (10 μg/cm³) for copper ions (Cu²⁺). For an identical volume of fluid (V), the rate of diffusion can change as a function of the contact surface area (S); the more hydrophilic the surface, the more spread out is the contact surface, and the more rapid is the diffusion of the bactericidal metal ions into the fluid. The maximum concentration of bactericidal metal ions that diffuse into the volume of the fluid is equal to (Cs×S/V), where Cs is the surface loading of bactericidal metal ions of the antibacterial surface. Because of the depths of grafting obtained for acceleration voltages of 1000 kV, it is impossible to store more than 1000 μg/cm³.

In various implementations of the method of the present invention, which may be combined one with another:
the organic material is movable relative to the ion beam at a speed V_{D} in the range 0.1 mm/s to 1000 mm/s. It is thus possible to move the sample in order to treat zones with a dimension that is larger than that of the beam. The speed of movement V_{D} may be constant or variable. In one implementation, the organic material is moved and the ion beam is stationary. In another implementation, the ion beam sweeps the organic material. It is also possible for the organic material to be moved while the ion beam is moving. In one implementation, the same zone of organic material is moved beneath the ion beam in a plurality, N, of passes at the speed V_{D}. It is thus possible to treat the same zone of an organic material with a dose of ions corresponding to the sum of the dose of ions received by this zone at the end of the N passes. It should also be noted that if the size of the organic material allows it, the treatment step may be static and result from one or more “flashes” of ions;
after treatment with the ion beam, air is let into the organic material before it is immersed in a liquid or an atmosphere of gases containing the monomers to be deep layer grafted. The lapse of time separating the ion beam treatment and immersion must be as short as possible in order to avoid combination with ambient oxygen and moisture. The immersion temperature should be selected so that the rate of diffusion of the monomers is compatible with the speed of movement below the ion beam and so that it does not induce a modification of the properties of the organic material as it returns to ambient temperature.

Various modifications are also possible for the skilled person without departing from the scope of the present invention as defined in the accompanying claims.

1. A method of surface treating a fluid dispenser device, comprising a step of modifying, by ionic implantation, by means of multi-charged and multi-energy ion beams, at least one surface to be treated of at least a portion of said device in contact with said fluid, said modified surface having properties limiting the appearance and/or proliferation of bacteria on said modified surface, said multi-charged ions being selected from helium (He), boron (B), carbon (C), nitrogen (N), oxygen (O), neon (Ne), argon (Ar), krypton (Kr), and xenon (Xe), ionic implantation being carried out to a depth of 0 μm to 3 μm.

2. A method according to claim 1, wherein said ion beam is created by an electron cyclotron resonance (ECR) source.

3. A method according to claim 1, wherein said multi-energy ions are implanted simultaneously with the same extraction voltage.

4. A method according to claim 1, wherein said at least one surface to be treated is formed from synthetic material, in particular comprising polyethylene (PE) and/or polypropylene (PP) and/or polyvinyl chloride (PVC) and/or polytetrafluoroethylene (PTFE).

5. A method according to claim 1, wherein said at least one surface to be treated is formed from an elastomer, a glass, or a metal.

6. A method according to claim 1, wherein said dispenser device comprises a reservoir containing the fluid, a dispenser member such as a pump or a valve attached to said reservoir, and a dispenser head provided with a dispenser orifice in order to actuate said dispenser member.

7. A method according to claim 1, wherein said fluid is a pharmaceutical fluid for spraying and/or inhaling nasally or orally.

8. A method according to claim 1, wherein said method is carried out continuously on an assembly line for the fluid dispenser device.

9. A method according to claim 1, wherein said method comprises a method of deep layer grafting monomers into an organic material, comprising two steps in succession:
a) a step of ionic bombardment by an ion beam:
to create a reservoir of free radicals in a layer (1) with a thickness e_{rad} in the range 20 nm to 3000 nm; and
to create a stabilizing layer (2) interposed between the surface and the reservoir of free radicals (1) with a thickness e_{stab} in the range 0 nm to 3000 nm;
the ions of the ion beam being selected from the ions of elements in the list constituted by helium (He), boron (B), carbon (C), nitrogen (N), oxygen (O), neon (Ne), argon (Ar), krypton (Kr), and xenon (Xe);
the ion acceleration voltage being greater than or equal to 10 kV and less than or equal to 1000 kV; and
the treatment temperature of the organic material is less than or equal to its melting temperature;
the ion dose per unit area being selected so as to be in the range 10¹² ions/cm² to 10¹⁸ ions/cm² by using a measurement of the change over time of the surface resistivity of the organic material to identify the dose that induces the greatest resistive jump step;
b) a step of grafting monomers, consisting of diffusing monomers (M) through a stabilizing layer (2) from the surface towards the reservoir of free radicals (1) at a diffusion temperature T_{d}.

10. A method according to claim 9, wherein said grafting step is followed by a step of immersion in a solution containing bactericidal ions.

11. A method according to claim 9 wherein for any ion, the step of selecting the dose of ions per unit area so as to create a stabilizing layer (2) and a reservoir of free radicals (1) is carried out on the basis of experimental data that have already been obtained indicating, for another type of ion at a given energy, the dose of ions per unit area that can produce the highest resistive jump step.

12. A method according to claim 9, wherein the dose of ions per unit area is preferably in the range 10¹³ ions/cm² to 5×10¹⁷ ions/cm².

13. A method according to claim 9, wherein the ion acceleration voltage is preferably in the range 20 kV to 200 kV.

14. A method according to claim 9, wherein the diffusion temperature T_{d} is in the range from ambient temperature to the melting temperature T_{f} of the organic material.

15. A method according to claim 9, wherein the monomers (M) that are selected have hydrophilic and/or hydrophobic and/or antibacterial properties.

16. A method according to claim 15, wherein for a given ion, the step of selecting the energy so as to create a surface loading of bactericidal metal ions stored in the grafted layer corresponding to the reservoir of free radicals (1) allowing a threshold bactericidal concentration specific to the bactericidal metal ions to be exceeded in a fluid (4) with volume (V) and contact surface area (S) is carried out on the basis of data that have already been established that can be used to represent the change in the number of bactericidal metal ions per unit area as a function of the thickness of the treatment, the bulk density of the polymer, the molar mass of the monomer constituting the polymer, the number of grafted monomers per monomer constituting the polymer, and the number of bactericidal metal ions bonded by the grafted monomer.

17. A method according to claim 9, wherein the organic material is movable relative to the ion beam at a speed V_{D} in the range 0.1 mm/s to 1000 mm/s.

18. A method according to claim 17, wherein the same zone of organic material is moved beneath the ion beam in a plurality, N, of passes at the speed V_{D}.

19. A method according to claim 9, wherein the organic material is selected from the list of materials belonging to the family of polymers, elastomers, or resins.
